(19) United States
(12) Patent Application Publication
(10) Pub. No.: US 2007/0038526 A1
(43) Pub. Date: Feb. 15, 2007

(54) System and method to optimally clear non-selling inventory

(75) Inventors: Jeffrey W. Painter, Lewis Center, OH (US); Ronald Steven Nakie, Columbus, OH (US); Philip Daniel Turner, Columbus, OH (US)

Correspondence Address: STOEL RIVES LLP;One Utah Center, Suite 1100, 201 S Main Street, Salt Lake City, UT, 84111-4904, US

(73) Assignee: The Cobalt Group, Inc.

(21) Appl. No.: 11/475,796

(22) Filed: Jun. 27, 2006

Related U.S. Application Data
(60) Provisional application No. 60/708,267, filed on Aug. 15, 2005.

(51) Int. Cl. G06Q 30/00

(52) U.S. Cl. 705/26

(57) ABSTRACT

A seller desiring to sell items in an inventory configures seller filters which are then applied to the inventory to provide a filtered inventory. Buyers configure buyer filters to indicate items that they are interested in purchasing. A match is found within the inventory that falls within the parameters established by a seller and buyer. The match leads to a prospective transaction which may be revised by the seller and buyer prior to confirmation of the transaction. Participation by the seller and buyers is enabled over a network to facilitate and automate the transaction.

### RELATED APPLICATIONS

This application claims priority to U.S. patent application Ser. No. 60/708,267 filed on Aug. 15, 2005, and entitled “Automated System to Optimally Clear Non-Selling Inventory with One or Multiple Buyers” which is hereby incorporated by reference.

### TECHNICAL FIELD

The present invention relates to inventory and transaction management systems and techniques.

### BACKGROUND

Situations frequently arise where a seller maintains a certain number of items in inventory that are idle. The inventory may be idle at certain store locations for a variety of reasons, all of which typically relate to customer demand. Idle inventory takes space and fails to generate revenue. A manager desiring to reduce idle stock and increase revenue flow may prepare a report of the idle stock. The report may then be sent in hardcopy form, facsimile, or email to another manager selling like merchandise. The recipient of the report is able to review the report and determine which, if any, of the idle stock to purchase based on demand. Items that are unwanted in one location may be in demand in another. A prospective buyer and seller can engage in negotiations to purchase some or all of a seller's idle stock. As can be appreciated, preparing and reviewing reports is a tedious and inefficient technique for reducing idle stock. The effort required to identify and reduce idle stock is a deterrent to any potential seller.

### BRIEF DESCRIPTION OF THE DRAWINGS

A more particular description of the invention will be rendered by reference to the appended drawings. Understanding that these drawings only provide information concerning typical embodiments of the invention and are not therefore to be considered limiting of its scope, the invention will be described and explained with additional specificity and detail through use of the accompanying drawings, in which:

FIG. 1 illustrates a block diagram of a system for performing inventory matching and transactions;

FIG. 2 illustrates a flow diagram for selecting eligible inventory;

FIG. 3 illustrates a flow diagram for generating a prospective transaction;

FIG. 4 illustrates a flow diagram of buyer involvement in a transaction;

FIG. 5 illustrates a flow diagram of seller involvement in a transaction; and

FIG. 6 illustrates a flow diagram for reactivating filtered inventory.

### DETAILED DESCRIPTION OF PREFERRED EMBODIMENTS

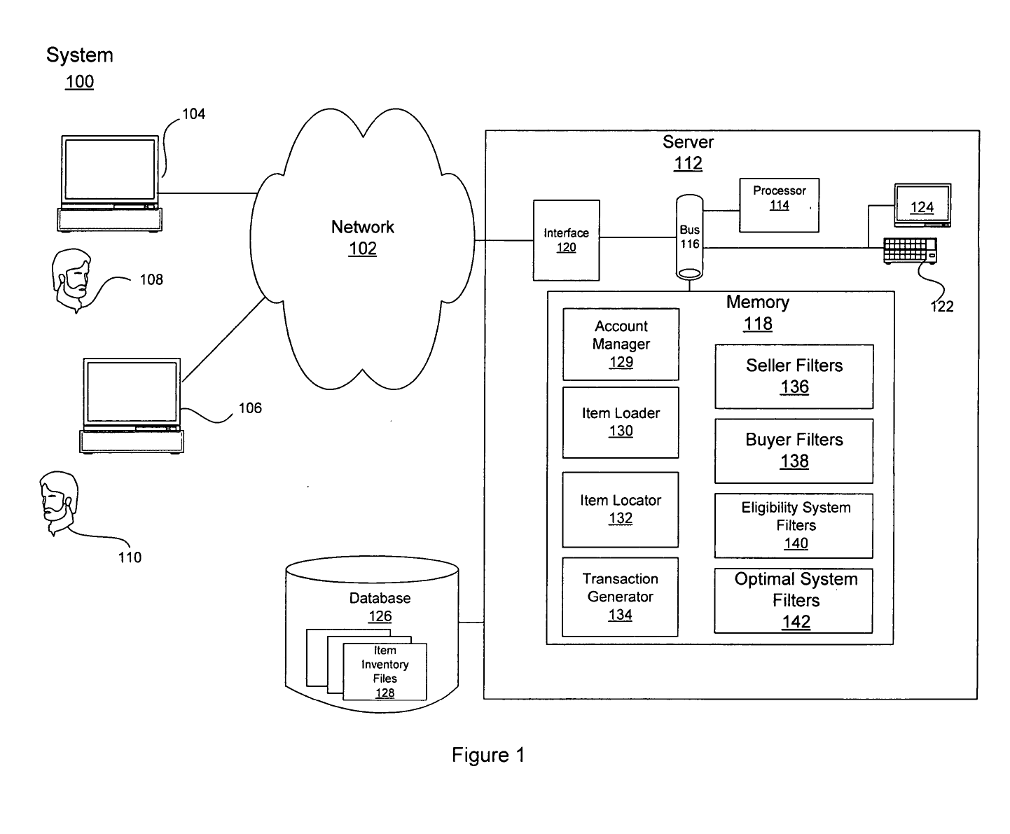

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1-6, is not intended to limit the scope of the invention, as claimed, but is merely representative of presently preferred embodiments of the invention.

Specific examples are given to illustrate aspects of the invention, but those of skill in the relevant art(s) will understand that other examples may also fall within the meaning of the terms used, and hence within the scope of one or more claims. Important terms may be defined, either explicitly or implicitly, here in the Detailed Description and/or elsewhere in the application file. In particular, an “embodiment” of the invention may be a system, an article of manufacture, a method, the product of a process, and/or a signal which configures a computer random access memory, disk, CD, DVD, or other computer-readable media.

The embodiments disclosed herein address problems associated with idle and obsolete parts in a seller's inventory. A store manager may have a report of idle stock prepared and submit the report to other store managers. Such a report submission, however, fails to provide filtering parameters that allow for effective matching between buyer and seller demands. A report also does not provide visibility on what parts have actually been sold in either buyer or seller inventories. Furthermore, automating part matching for proposed transactions greatly enhances the likelihood of transactions actually occurring.

A system disclosed herein operates in a computer network to match a seller's idle and/or obsolete inventory with one or more buyers' inventory demands. The inventory discussed herein includes tangible items for sale in commerce. The system receives inputted seller inventory and posts the seller inventor. The inventory may be reduced in price to prompt a transaction while still providing revenue. The system applies configurable seller filters to determine which items the seller might consider offering for sale as overstocked or obsolete. The system provides for seller configurability for items available for sale. In this manner, a seller can exclude certain items for consideration. The system may allow for seller review before making the selected inventory available for transactions, or alternately, the filtered inventory can pass directly to an active state. In the active state, the system inputs buyer inventory and applies configurable buyer filters to determine which items a buyer may be willing to purchase.

Using the seller and buyer filters and additional configurable system filters, the system locates eligible buyers. From the list of eligible buyers, the system uses a second set of system filters to determine an optimal buyer. The items are offered to an optimal buyer in a proposed transaction. A notification is sent to the optimal buyer that a proposed transaction is available for buyer review. The system allows selection as to the manner of notification to the optimal buyer, such as by email, fax, voice message, pager, or other communication.

A buyer then has opportunity to review items matched between the seller and the buyer. The buyer has the opportunity to edit the transaction, optionally revising the quantity for each item in the transaction downward. At any time, the buyer has the opportunity to accept the edited transaction or to reject the entire transaction. The system may remind a buyer periodically that there is a proposed transaction available for review. If the buyer does not accept the transaction within a certain period of time, the transaction expires and terminates. The system then searches for another optimal buyer. If the buyer declines the suggested transaction, the invention returns to searching for another optimal buyer.

If the buyer accepts the proposed transaction, then the system notifies the seller that a proposed transaction is available for review. The seller has an opportunity to review the proposed transaction and make changes, accept, or decline. The system will remind the seller periodically that a proposed transaction is available for review. If the seller does not accept the proposed transaction within a certain period of time, then the proposed transaction expires and terminates. The system may then search for another optimal buyer. If the seller accepts the proposed transaction, the seller's list of obsolete/idle items is decremented according to the quantities in the transaction. The system may close the filtered inventory when the seller either rejects the transaction or when a seller allows a transaction to expire. Notification is sent to both buyer and seller that a transaction has been consummated. In this manner, a system provides automated match generation and transactions over a computer network.

Referring to FIG. 1, an embodiment of a system 100 for automated transaction is shown. Human administrators may oversee operations, and the system may be driven by data and/or commands from human users. Infrastructure that may be implemented in the system 100 is readily available. For example, general purpose computers, computer programming tools and techniques, computer networks and networking technologies, digital storage media, authentication, access control, and other security tools and techniques provided by public keys, encryption, firewalls, and/or other means, bank transfers, credit card processing, digital money, and other tools and techniques for making payments may be incorporated into the system 100.

The system 100 includes a network 102 that may be implemented as one or more local area networks, wide area networks, metropolitan area networks, and/or “Internet” or IP networks, such as the World Wide Web, a private Internet, a secure Internet, a value-added network, a virtual private network, an extranet, an intranet, or even a PSTN. In particular, a suitable network may be formed from parts or entireties of two or more other networks, including networks using disparate hardware and network communication technologies. The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

The network 102 may be operated in communication with a plurality of computers. For simple illustration, a buyer computer 104 and a seller computer 106 are shown. The buyer computer 104 and seller computer 106 are shown in association with a respective buyer 108 and a seller 110. Reference is made herein to sellers and buyers who may be human parties, humans, or any entity, such as an individual, corporation, limited liability company, foundation, partnership. A seller is any inventory holder that identifies and sells a number of instances of overstocked or obsolete items.

The computers 104, 106 may be a workstation, laptop computer, disconnectable mobile computer, server, mainframe, cluster, so-called “network computer” or “thin client,” personal digital assistant or other hand-held computing device, “smart” consumer electronics device or appliance, or a combination thereof.

The system 100 includes a server 112 that hosts operations to filter and match inventory for clearance through a transaction. The server 112 includes a processor 114 which may include a general purpose device, such as a 80.times.86, Pentium (mark of Intel), 680.times.0, or other “off-the-shelf” microprocessor. The processor 114 may include a special purpose processing device, such as an ASIC, PAL, PLA, PLD, Field Programmable Gate Array, or other customized or programmable device. The processor 114 is in electrical communication with a bus 116 to communicate with components of the server 112.

The server 112 includes a memory 118 that may include a number of different memory components including static RAM, dynamic RAM, flash memory, ROM, CD-ROM, disk, tape, magnetic, optical, or other computer storage medium. The memory 118 includes computer readable instruction code to perform operations in a manner as described herein. Thus, the memory 118 embodies a program, functions, and/or instructions that are executable to provide inventory filtering, inventory matching, on-line transacting, and otherwise help facilitate transactions. Likewise, communication mediums and other data carriers and hard drives and memory may embody signals for performing transactions as described herein.

Suitable software to assist in implementing operation is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

The server 112 further includes an interface 120 to provide a gateway for communicating with the network 102. The server 112 may also include input devices 122 and output devices 124. The input devices 122 may include a keyboard, mouse, touch screen, light pen, tablet, microphone, sensor, or other hardware with accompanying firmware and/or software. The output devices 124 may include a monitor or other display, printer, speech or text synthesizer, switch, signal line, or other hardware with accompanying firmware and/or software.

The system 100 includes a database 126 that is populated with item inventory files 128 and is in communication with the server 112. The database 126 may be formatted and embodied in variety of ways known in the art. The item inventory files 128 may be embodied as text files or other files known in the art. Part inventory files 128 may have an attribute that marks the file 128 for the system 100. The attribute may be a role and can be identified as “buyer,” “seller,” or “both.”

The computer readable programs, functions, and instructions resident in the memory 118 may be described as modules. The memory includes an account manager 129 that allows users, such as buyers and sellers 108 and 110, to establish and manage accounts with the system 100. In establishing an account, a user is able to participate in a transaction. The account may be associated with a business entity rather than an individual user. When a user subsequently accesses the server 112, the user is able to log-in using any one of a number of various techniques.

The memory 118 includes an item loader 130 that loads item inventory files 128 into the database 126 and appropriately marks the item inventory files 128. The memory 118 further includes an item locater 132 to retrieve available item inventory files 128 from the database 126. The memory 118 further includes a transaction generator 134 to identify proposed transactions and manage a transaction.

The memory 118 also includes configurable seller filters 136 that determine which inventory items are to be listed as available for a transaction. The seller filters 136 may include maximum cost for an item (the amount paid by a seller to purchase one item), maximum extended cost for an item (the amount paid to purchase one item multiplied by the quantity of the item on hand), minimum cost for an item, minimum extended cost for the item, number of months with no sales (months since the last sale) for the item, a list of items to exclude from consideration, items for which there is a “core” charge (the cost attached to the “core” of an item that can be re-used, rebuilt, or recycled), source codes (for grouping together parts by manufacturer/vendor, similar type/function, requisite days supply criteria, ordering criteria; etc.), and stocking statuses (codes indicating whether the part is normally stocked, special order, not to be restocked, etc.). As can be appreciated, the number of factors and parameters that may be included within the seller filters 136 is infinite, and only a few are disclosed for exemplary purposes. A seller 110 may log-in and configure the seller filters 136 as permitted by the server 112.

The memory includes buyer filters 138 that are configurable by a participating buyer. Criteria for buyer filters 138 may include maximum cost for an item, maximum extended cost for the item, minimum cost for the item, minimum extended cost for the item, quantity of the item sold over the last x number of months, year sales ratio which is the (quantity on hand+quantity on order)/sales over the last 12 months, a list of items to exclude from consideration as demanded items, items for which there is a core charge, maximum number of months for which the part has not experienced any sales, source codes, and stocking statuses. A buyer 108 may access the server 112, log-in, and configure the buyer filters 138.

The memory further includes eligibility system filters 140 for determining if a buyer is eligible. The eligibility system filters 140 may include the minimum number of days since the seller last matched to the buyer, a maximum number of transactions that can be concurrently offered (open) to a buyer, maximum purchase limit per month established by each buyer (represents a monetary limit, measured in the seller cost of each item, of what a buyer is willing to purchase through the system in any one calendar month), minimum transaction amount established by each buyer (determines a monetary lower limit, measured in seller cost of each item, for the aggregate match of items that the seller is willing to sell with the items that the buyer is willing to purchase), minimum transaction amount established by a seller, a list of refused buyers maintained by a seller (buyers with whom the seller refuses to transact), a list of refused sellers maintained by the buyer (sellers with whom the buyer refuses to transact), and a vacation schedule for the buyer maintained by the buyer. The eligibility system filters 140 may be configured by a system administrator.

The memory further includes optimal system filters 142 to be used in determining an optimal buyer. The optimal system filters 142 may include dollar amount of a seller's obsolete items which match a buyer's demanded items, number of months since the system last offered a transaction (an opportunity to purchase items from a seller) to a buyer, the number of transactions declined by a buyer (representing the number of times the system offered a buyer an opportunity to purchase parts from a seller and a buyer declined to purchase any), the number of transactions allowed to expire with a buyer (the number of times the system offered a buyer an opportunity to purchase parts from a seller and a buyer never responded to the transaction opportunity by either declining or accepting the opportunity), an internal rating factor (a subjective measure of the performance of a buyer), geography as distance between the buyer and seller, a part count match factor which is a percentage of a seller's parts matched with a buyer, the time since a buyer last received a match, a list of preferred buyers maintained by a seller (associated with each preferred buyer is a priority to determine ranking within the tier of preferred buyers), a list of preferred sellers maintained by a buyer (associated with each preferred seller is a priority to determine ranking within the tier of preferred sellers), a setting by which each party can restrict transactions to only those on the party's preferred buyer or seller list, and a list of family buyers tied to the seller by a dealer grouping. The optimal system filters 142 may also include a scratch factor, which is derived from the historical data and reflects the percentage of items offered to a buyer which the buyer refuses. The optimal system filters 142 may be configured by a system administrator.

The impact of each system criterion for the system filters 140, 142 can be adjusted. For example, a criterion could be adjusted to weight the geographical criterion heavier than the number of transactions declined by a buyer. Also, the system filters 140, 142 may be configured to reflect how many transactions or days to use in order to develop the statistics to which the factors and weightings are applied. For example, the system filters 140, 142 could be configured to use at most the last twelve transactions in order to compute the Scratch Factor, and to require a minimum of three transactions to average for the Scratch Factor to count in the computation to determine an optimal buyer. Another option is to configure the number of days of transactions to use in order to compute the averages along with a minimum transaction count. As can be appreciated, the system filters 140, 142 may be configured in various ways to reflect a number of options.

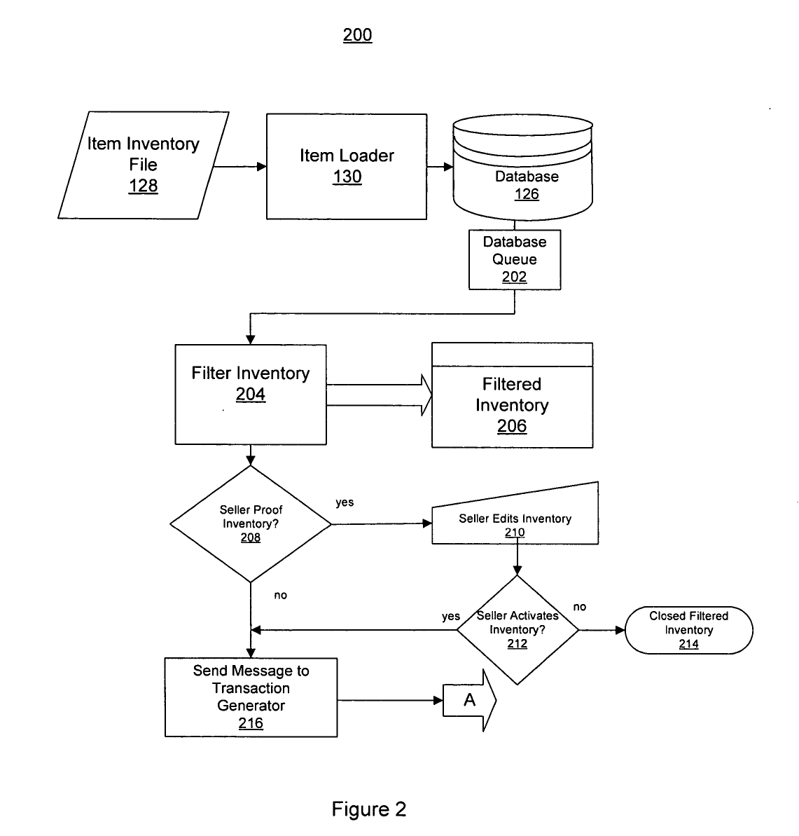

Referring to FIG. 2, a flow diagram illustrates a process 200 for generating filtered inventory. In order to populate the database, the item loader 130 stores item inventory files 128 into the database 126. The item inventory files 128 are provided by the seller 110. Subsequent operations in FIG. 2 may be performed by the item locater 132. If a seller starts the process 200, items reflected in item inventory files 128 are moved into the database queue 202. Specifically, the item locator 132 moves item inventory files 128 into the database queue 202 for access and retrieval. The item locator 132 then filters 204 the item inventory files 128 based on the seller filters 136.

The seller filters 136 may include various criteria and parameters that are configured by a seller as desired and are reflected in the seller filters 136. A primary factor for a filter may be the number of months without a sale. As can be appreciated, additional configurable factors may be applied in filtering items. Furthermore, an item exclusion list may be applied to the inventory as a seller filter 136. In one embodiment, the seller filters 136 may allow for a completely open inventory, in which case no items are filtered. No filtering may also exist in an auction situation, which is a special case. Filtering the item inventory files 128 generates a filtered inventory 206 representing items for transaction.

The filtering process may be entirely automated in that a seller is not involved in providing inventory available for a transaction. However, the process 200 may allow an option for a seller to proof 208 the filtered inventory 206. Seller interaction may be provided through network communication with the seller computer. A seller may be notified of the proofing option through email, telephone, facsimile, pager or other conventional methods. If the seller chooses to proof the inventory, then the seller may also edit 210 the filtered inventory 206. A seller can edit identified item quantities up or down. A seller may also completely exclude items, if desired.

Upon completion of editing 210 the filtered inventory 206, a seller decides whether or not to activate 212 the inventory. Activating the filtered inventory 206 indicates that the inventory 206 is available for a transaction. If the seller does not activate the filtered inventory 206, the inventory 206 is closed 214, and the process 200 terminates. If the inventory 206 is activated, then a message is sent 216 to the transaction generator 134 to initiate. Likewise, if seller proofing is not available, the message is sent 216.

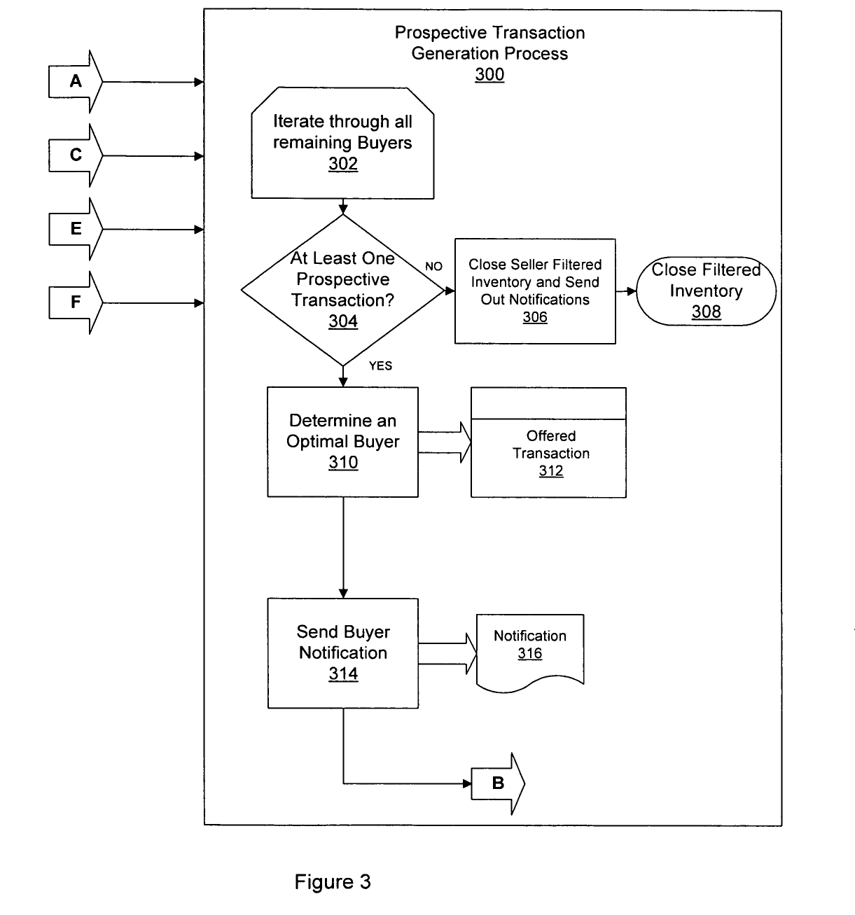

Referring to FIG. 3, a flow diagram illustrates a process 300 performed by the transaction generator 134 to generate a prospective transaction. The transaction generation 134 begins by iterating 302 through all remaining buyers. The transaction generator 134 compares seller inventory against a list of parts a buyer is willing to purchase. Buyer filters 138 are applied to determine 304 if at least one prospective transaction exists. The buyer filters 138 include selection criteria rules and item exclusions, which are applied to match line items to the seller filtered inventory 206.

A buyer filter 138 may include minimum and maximum pricing for an item. Accordingly, both the buyer and seller price filtering are applied in the processes 200, 300. A buyer filter 138 may also include the make and/or manufacturer of certain items. For example, for automobile parts, a buyer may be affiliated with General Motors, Chrysler, Toyota, etc. A buyer may be eligible for only certain makes and manufacturers for compatibility. Another buyer criterion for purchasing is the number of times a part has sold in the last year.

Furthermore, determining 304 a prospective transaction involves applying system eligibility filters 140 as well. For example, a system eligibility filter 140 includes system price minimums and maximums. Eligibility filters 140 may be configured by a system operator to include a list of refused buyers, buyers who have not recently purchased parts, buyers who have turned down transactions, buyers who are on vacation or who are otherwise unavailable, and a buyer list for refused sellers.

A transaction intersection is determined between buyers and sellers to determine 304 if at least one prospective transaction exists. The transaction intersection includes a list of buyers and sellers who, among other considerations, have overlapping price ranges. If a prospective transaction does not exist, then notifications may be sent 306 to the system operator that the seller filtered inventory 206 is closed. The seller filtered inventory 206 is then closed 308 to indicate that the filtered inventory 206 is unavailable for transactions. Closed filtered inventory 206 must be reactivated in order to become available for a transaction.

After determining 304 that there is a prospective transaction, the transaction generator 134 determines the optimal buyer 310. The determination 304 may include application of additional seller filters 136 and the optimal system filters 142. Obviously, a factor in finding an optimal buyer is the buyer's offered price. A system provider may receive a commission on the transaction, and locating the highest price is desired. Thus, highest price may be a seller filter 136 and an optimal system filter 142.

A seller filter 136 may include a preference to sell to an associated store for a reduced price rather to a competitor. A system operator, on the other hand, may not be concerned with such a preference. Optimal system filters 142 may include the amount of time since a buyer was last offered a transaction. If a buyer has not had a transaction in a long time, a buyer may loose interest in participating. Additional optimal system filters 142 may include the amount of time since a buyer has sold such an item, peer-to-peer ratings based on surveys, or other additional internal factors.

A peer-to-peer survey includes questions that are scored to produce an aggregated value. The questions relate to transacting with an entity. The aggregated value then produces a factor to be used in matching entities. In effect, a seller factor determines if a seller can participate. Seller factors tend to be more of a pass/fail rating. A buyer factor affects a ranking of buyers as buyers are more in competition with one another for a transaction.

The scratch factor referred to above is a situation that may occur during buyer editing. A buyer may have the opportunity to edit a proposed transaction. During buyer editing, a buyer may heavily edit an inventory and thereby “cherry pick” selected parts. Typically, a seller prefers to sell a whole listed inventory. The scratch factor indicates when a buyer was last matched to a proposed transaction as initially presented. Thus, the scratch factor is indicative of how heavily a buyer edits down an initially presented, proposed transaction. The scratch factor may be developed by evaluating a minimum of x and a maximum of y transactions, which are set by system parameters. The scratch factor is then calculated by taking a percentage of dollar value for the items accepted by the buyer measured against the dollar value for the items initially presented to the buyer.

In one embodiment, determining an optimal buyer 310 may be based on configurable settings. The transaction generator 134 may include a system setting table that is based on a range of weights or factors. For example, with respect to distance and geography, since the seller typically pays for the shipping charges, a prospective transaction with a buyer closer to the seller would be ranked higher in preference than a similar transaction with a buyer further away from the seller.

Optimal buyers may also be grouped into different tiers. For example, a first tier may include a list of preferred buyers associated with the seller. The seller may personally determine which buyers are included in the first tier. A second tier may include a list of preferred buyers associated with a family of sellers. A third tier may include all remaining eligible buyers. Preference in finding an optimal buyer may be weighted to the higher tiers. In one embodiment, a sufficiently high price may provide an optimal buyer from a lesser tier. Alternatively, the optimal buyer may always be selected from a first tier if available. In this embodiment, none of the parameters in the optimal system filters 142 will cause the system to select an optimal buyer from a lower tier if a higher tier buyer is available.

Upon determining an optimal buyer 310, an offered transaction 312 is generated. The offered transaction may be a list of one or more items offered from the seller to one buyer. The process 300 then sends 314 notification 316 to the selected, optimal buyer. The notification 316 may be sent in a variety of ways, such as by email or fax.

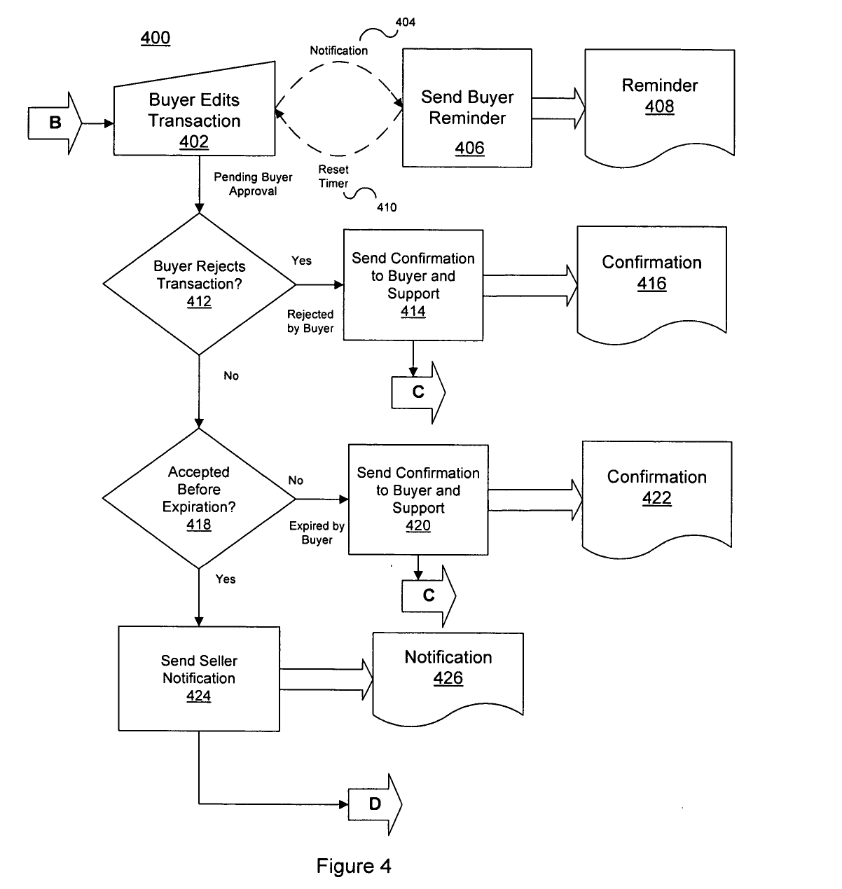

Referring to FIG. 4, a flow diagram illustrates a buyer process 400 in the transaction. The process 400 may be performed by the transaction generator 134. The buyer's involvement begins after the buyer has received notification 316. The buyer may be provided with an option to edit 402 a transaction. However, the buyer cannot reduce a transaction below seller and system minimums. The system initiates a notification 404 to send 406 the buyer a reminder of a pending transaction. The reminder 408 may be embodied as an email or facsimile. After sending the reminder 408, a buyer timer is reset 410. The buyer timer tracks the amount of time in which a buyer can accept the proposed transaction. The amount of time is a configurable system setting.

After editing 402, a buyer is able to reject 412 the proposed transaction. In this event, the buyer is no longer eligible for the originally proposed transaction. If the buyer rejects 412 the transaction, then confirmation is sent 414 to the buyer and to a system support. The confirmation 416 may be in the form of email or facsimile. The process 400 moves to process 300 to generate another proposed transaction.

If the buyer does not reject 412 the proposed transaction, it is determined whether the buyer accepted 418 the proposed transaction before timer expiration. If not, the buyer is deemed to have rejected the transaction. Confirmation is sent 420 to the buyer and to system support. The confirmation 422 may be in the form of email or facsimile. The process 400 moves to process 300 to generate another proposed transaction.

If the buyer accepts 418 the proposed transaction within the given amount of time, then notification is sent 424 to the seller. The notification 426 may be in the form of email or facsimile. The notification 426 includes information as to whether or not a proposed transaction was edited by the buyer.

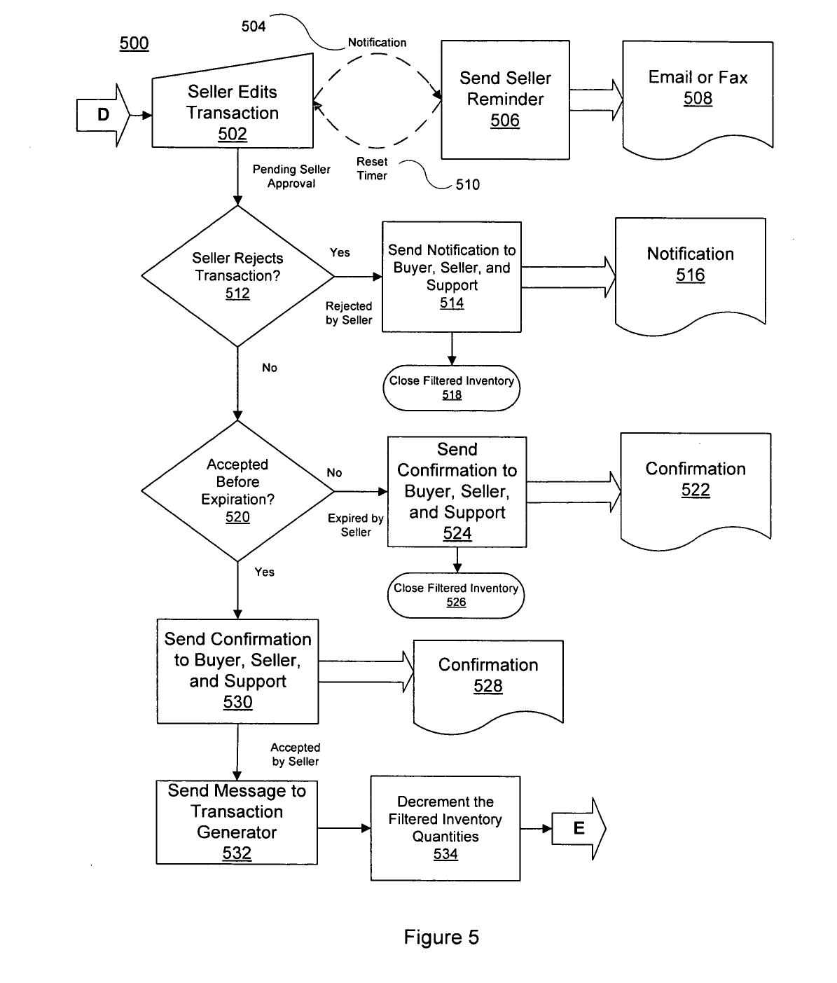

Referring to FIG. 5, a flow diagram illustrates a seller process 500 in the transaction. The seller process 500 may be performed by the transaction generator 134. Upon receiving notice of buyer acceptance, the seller may edit 502 the proposed transaction. The seller cannot edit the proposed transaction beyond buyer and system parameters. The seller may also choose not to edit the proposed transaction. The system initiates a notification 504 to send 506 the seller a reminder of a pending transaction. The reminder 508 may be embodied as an email or facsimile. After sending the reminder 508, a seller timer is reset 510 which tracks the amount of time in which a seller can accept the proposed transaction. The time for seller acceptance is a configurable system setting.

After a seller completes editing 502, the seller may reject 512 the transaction. If the seller rejects 512 the transaction, the notification is sent 514 to the buyer, seller, and the system support. The notification 516 may be embodied as email or a facsimile. The system further closes 518 the filtered inventory, and the proposed transaction is terminated. Alternatively, the seller may be offered a choice of whether to close the filtered inventory or attempt to generate another proposed transaction. In either case, the current proposed transaction is terminated.

If the seller does not reject 512 the transaction, then a determination is made as to whether the seller accepted 520 before expiration of the timer. If the seller did not accept in time, then notification 522 is sent 524 to the buyer, seller, and the system support. The system closes 526 the filtered inventory, and the proposed transaction is terminated. If the seller accepts 520 the proposed transaction prior to the expiration of the timer, then confirmation 528 of acceptance is sent 530 to the buyer, seller, and the system support.

A message is sent 532 to the transaction generator 134 to confirm acceptance by both the seller and the buyer. Next, the filtered inventory is decremented 534 to reflect the accepted transaction. The decremented filtered inventory is then reflected in the corresponding item inventory files 128. The process 500 proceeds to the transaction generation process 300 to generate another prospective transaction.

The system may establish a maximum number of times that a buyer may reject a transaction or exceed the buyer timer before the filtered inventory is closed. The system allows for repeated opportunities for a buyer to accept a proposed transaction within the amount of given time. This is because events may occur that can create a completed transaction where previous proposed transactions failed. For example, buyers may have been out of the office and recently returned. Buyers may only budget for a certain number of transactions in a given time period, such as a month. At the beginning of a new month, a budget may allow for new transactions.

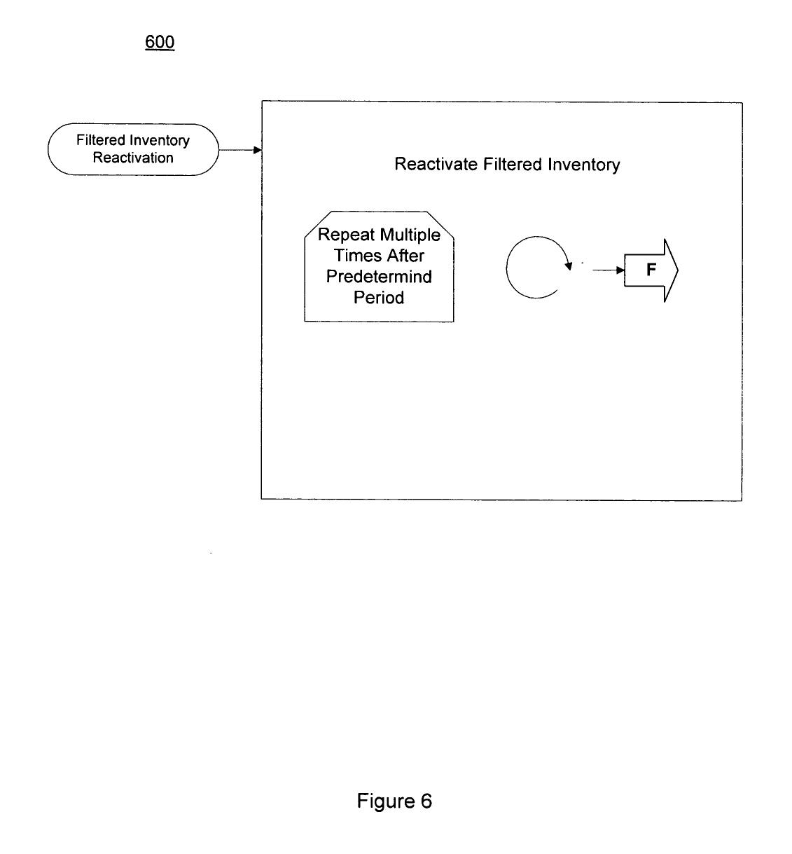

Referring to FIG. 6, a process 600 is shown for reactivating filtered inventory. The system allows for repeated attempts to generate new proposed transactions for the same filtered inventories. The transaction generator 134 may wait for a certain period of time, which is referred to herein as a reactivation delay. After the reactivation delay, the transaction generator 134 attempts to generate a new proposed transaction for the reactivated filtered inventory. As can be appreciated, events may change that would create a transaction. Buyers may alter their filters, have new demand, and require items not previously desired. New buyers may participate in the system and represent new opportunities for a transaction. Thus, the system may repeatedly search for prospective transactions.

The transaction generator 134 may perform a number of predetermined iterations, each iteration including a reactivation delay and an attempt to generate a proposed transaction. After the predetermined number of iterations, the transaction generator 134 may close the filtered inventory and so notify the system operator.

The system and techniques discloses herein allow a seller to configure filters to sell certain items while excluding other items. For example, a seller may wish to sell special order items or items that have had a long shelf life. A buyer is able to configure filters to select only certain items for purchase. Matching and comparison between seller items and buyer items is automated to produce an optimal match. Furthermore, a transaction may be performed through a network interface to greatly facilitate participation. Both the seller and buyer may edit a prospective transaction through the network interface. The system timely notifies both parties of the prospective transaction, proposed edits, and confirmation to both parties.

It will be obvious to those having skill in the art that many changes may be made to the details of the above-described embodiments without departing from the underlying principles of the invention. The scope of the present invention should, therefore, be determined only by the following claims.

1. A server accessible over a network to provide a transaction for the sale of items, the server comprising:
an interface to enable access to the network; and
a memory in electrical communication with the interface to store computer executable modules, including,
seller filters having configurable parameters to filter an inventory and generate a filtered inventory representing items for sale by the seller,
buyer filters having configurable parameters, and
a transaction generator to compare the filtered inventory and the buyer filters to generate at least one prospective transaction associated with one of the plurality of buyers.

2. The server of claim 1, wherein the seller filters are configurable by a seller over the network.

3. The server of claim 1, wherein the buyer filters are configurable by a plurality of buyers over the network

4. The server of claim 1, wherein the memory further comprises system filters and the transaction generator compares the filtered inventory to the system filters to generate the at least one prospective transaction.

5. The server of claim 4, wherein the system filters are configurable by a system administrator.

6. The server of claim 4, wherein the system filters include eligibility system filters to determine if each one of the plurality of buyers is eligible to participate in a prospective transaction.

7. The server of claim 4, wherein the system filters include optimal system filters for selection of an optimal transaction from the plurality of prospective transactions.

8. The server of claim 7, wherein the optimal system filters include the amount of time since a buyer was last offered a prospective transaction.

9. The server of claim 1, wherein the memory further includes an item loader to load item inventory files into a database accessible by the server.

10. The server of claim 9, wherein the memory further includes an item locator to retrieve the item inventory files which represent the inventory.

11. The server of claim 1, further comprising an account manager to establish accounts for the seller and the buyers and thereby enable seller and buyers access to the server.

12. The server of claim 1, wherein the transaction generator is to further enter buyer edits for the prospective transaction.

13. The server of claim 1, wherein the transaction generator is to provide a set amount of time in which the buyer may accept the prospective transaction.

14. The server of claim 1, wherein the transaction generator is to further enter seller edits for the prospective transaction.

15. The server of claim 1, wherein the transaction generator is to provide a set amount of time in which the seller may accept the prospective transaction.

16. The server of claim 1, wherein the seller filters include the amount of time since an item last sold.

17. A method for transacting for the sale of items over a network, comprising:
providing seller filters that are configurable by a seller over the network;
filtering an inventory based on the seller filters to generate a filtered inventory representing items for sale by the seller;
providing buyer filters that are configurable by a plurality of buyers over a network; and
generating at least one prospective transaction associated with one of the plurality of buyers by applying the buyer filters to the filtered inventory.

18. The method of claim 17, further comprising loading item inventory files representative of the inventory into a database.

19. The method of claim 18, further comprising accessing the database and retrieving the item inventory files.

20. The method of claim 17, further comprising:
providing configurable system filters; and
wherein generating at least one prospective transaction associated with one of the plurality of buyers includes applying the buyer filters to the filtered inventory.

21. The method of claim 20, wherein the system filters include eligibility system filters to determine if each one of the plurality of buyers is eligible to participate in a prospective transaction.

22. The method of claim 20, wherein the system filters include optimal system filters and wherein the method further comprises,
generating a plurality of prospective transactions with each prospective transaction corresponding to a buyer; and
applying the optimal system filters to select an optimal transaction from the plurality of prospective transactions.

23. The method of claim 17, further comprising enabling a buyer to edit the prospective transaction over the network.

24. The method of claim 17, further comprising:
providing a set amount of time in which the buyer may accept the prospective transaction; and
receiving over the network a buyer's response to the prospective transaction.

25. The method of claim 17, further comprising enabling a seller to edit the prospective transaction over the network.

26. The method of claim 17, further comprising:
providing a set amount of time in which the seller may accept the prospective transaction; and
receiving over the network a seller's response to the prospective transaction.

27. The method of claim 17, further comprising:
receiving notification that the prospective transaction is rejected;
closing the filtered inventory;
reactivating the filtered inventory; and
applying the buyer filters to the reactivated filtered inventory to attempt to generate a second prospective transaction associated with one of the plurality of buyer filters.

28. A computer readable medium having computer readable instruction code for performing a method for transacting for the sale of items over a network, the method comprising:
providing seller filters that are configurable by a seller over the network;
filtering an inventory based on the seller filters to generate a filtered inventory representing items for sale by the seller;
providing buyer filters that are configurable by a plurality of buyers over a network; and
generating at least one prospective transaction associated with one of the plurality of buyers by applying the buyer filters to the filtered inventory.

29. The computer readable medium of claim 28, wherein the method further comprises loading item inventory files representative of the inventory into a database.

30. The computer readable medium of claim 29, wherein the method further comprises accessing the database and retrieving the item inventory files.

31. The computer readable medium of claim 28, wherein the method further comprises:
providing configurable system filters; and
wherein generating at least one prospective transaction associated with one of the plurality of buyers includes applying the buyer filters to the filtered inventory.

32. The computer readable medium of claim 31, wherein the system filters include eligibility system filters to determine if each one of the plurality of buyers is eligible to participate in a prospective transaction.

33. The computer readable medium of claim 31, wherein the system filters include optimal system filters and wherein the method further comprises,
generating a plurality of prospective transactions with each prospective transaction corresponding to a buyer; and
applying the optimal system filters to select an optimal transaction from the plurality of prospective transactions.

34. The computer readable medium of claim 28, wherein the method further comprises enabling a buyer to edit the prospective transaction over the network.

35. The computer readable medium of claim 28, wherein the method further comprises:
providing a set amount of time in which the buyer may accept the prospective transaction; and
receiving over the network a buyer's response to the prospective transaction.

36. The computer readable medium of claim 28, wherein the method further comprises enabling a seller to edit the prospective transaction over the network.

37. The computer readable medium of claim 28, wherein the method further comprises:
providing a set amount of time in which the seller may accept the prospective transaction; and
receiving over the network a seller's response to the prospective transaction.

38. The computer readable medium of 28, wherein the method further comprises:
receiving notification that the prospective transaction is rejected;
closing the filtered inventory;
reactivating the filtered inventory; and
applying the buyer filters to the reactivated filtered inventory to attempt to generate a second prospective transaction associated with one of the plurality of buyer filters.

39. A server accessible over a network to provide a transaction for the sale of items, the server comprising:
interface means for enabling access to the network; and memory means in electrical communication with the interface means for storing computer executable modules, including,
seller filtering means configurable by a seller over the network for filtering an inventory and generating a filtered inventory representing items for sale by the seller,
buyer filtering means configurable by a plurality of buyers over the network, and
transaction generator means for comparing the filtered inventory and the buyer filtering means to generate at least one prospective transaction associated with one of the plurality of buyers.

40. A method for transacting for the sale of items over a network, comprising:
providing seller filters that are configurable by a seller over the network;
filtering an inventory corresponding to the seller based on the seller filters to generate a filtered inventory representing items for sale by the seller;
providing buyer filters that are configurable by a plurality of buyers over a network;
providing configurable system filters including eligibility system filters to determine if each one of the plurality of buyers is eligible to participate in a prospective transaction;
generating a prospective transaction associated with one of the plurality of buyers by applying the buyer filters and the system filters to the filtered inventory;
enabling a buyer to edit the prospective transaction over the network; providing a set amount of time in which the buyer may accept the prospective transaction;
receiving over the network a buyer's response to the prospective transaction;
enabling a seller to edit the prospective transaction over the network;
providing a set amount of time in which the seller may accept the prospective transaction; and
receiving over the network a seller's response to the prospective transaction.
